(19) United States
(12) Patent Application Publication
(10) Pub. No.: US 2020/0091573 A1
(43) Pub. Date: Mar. 19, 2020

(54) Energy-Storage Housing Having a Cooling Connection, Energy-Storage Unit and Motor Vehicle Having Such An Energy Storage Unit

(71) Applicant: Bayerische Motoren Werke Aktiengesellschaft, Muenchen (DE)

(72) Inventors: Florian EINOEGG, Biessenhofen (DE); Christian PAUL, Bad Aibling (DE); Andreas RING, Olching (DE); Markus STOLL, Muenchen (DE)

(21) Appl. No.: 16/690,385

(22) Filed: Nov. 21, 2019

Related U.S. Application Data
(63) Continuation of application No. PCT/EP2018/063237, filed on May 18, 2018.

(30) Foreign Application Priority Data
May 22, 2017 (DE) 10 2017 208 617.3

(51) Int. Cl. H01M 10/6568; H01M 10/625; H01M 2/10

(52) U.S. Cl. CPC H01M 10/6568; H01M 2250/20; H01M 2/1072; H01M 10/625

(57) ABSTRACT

An energy-storage housing has a cooling connection and a coolant distributor for channeling coolant or refrigerant in the interior of the energy-storage housing. The cooling connection has: at least one connection-pipe component, which is fitted on the coolant distributor; at least one sealing-pipe component, which passes through a wall of the energy-storage housing such that a gap which surrounds the sealing-pipe component remains between the sealing-pipe component and a wall opening; and an attachment, having at least one attachment-pipe component. The connection-pipe component, the sealing-pipe component and the attachment-pipe component are components which can be fitted one on the other and, in the fitted-together state, form a pipe via which it is possible to reach the coolant distributor, for coolant or refrigerant circulation, from outside the energy-storage housing. The attachment can be positioned on the sealing-pipe component and the gap from the outside, the attachment therefore closing the gap.

### CROSS REFERENCE TO RELATED APPLICATIONS

This application is a continuation of PCT International Application No. PCT/EP2018/063237, filed May 18, 2018, which claims priority under 35 U.S.C. § 119 from German Patent Application No. 10 2017 208 617.3, filed May 22, 2017, the entire disclosures of which are herein expressly incorporated by reference.

### BACKGROUND AND SUMMARY OF THE INVENTION

The invention relates to an energy store housing having a cooling connection and having a coolant channel for guiding coolant or refrigerant in the interior of the energy store housing. Furthermore, the invention relates to an energy store having such an energy store housing, and to a motor vehicle having such an energy store.

For the purpose of ensuring the range, service life and retrievable power of electric and hybrid vehicles, a defined thermal management system of the energy store is necessary. For this purpose, use is made of active and passive cooling systems. The cooling arrangement should in this case be integrated in a manner optimized with respect to installation space as much as possible, since a relatively low installation space requirement of the cooling construction permits a relatively large number of, or relatively large, cells, and the range of the vehicle is thereby increased.

The liquid-cooling arrangement as illustrated schematically in FIG. 1 constitutes a widely used and effective cooling arrangement. For this, cooling line systems which are able to guide and distribute the cooling liquid are required. For example, provision may be made of coolant distributors 1 which guide the coolant in the energy store housing and of which one forms a supply line and the other one forms a return line. Branching off from said coolant distributors 1 are lines which lead to individual cooling plates, which cool the energy storage modules of the energy store.

A cooling connection 2 is affixed to a housing wall 3 and serves for connecting the lines which lead to the cooling circuit, that is to say they form an inlet and outlet for the part of the energy store cooling system integrated in the energy store housing. For the purpose of connecting the cooling connection 2 to the coolant distributor 1, coolant hoses 4 are provided. Said coolant hoses 4 have the advantage that they substantially decouple the cooling connection 2 from the coolant distributor 1 with respect to mechanical forces. It is thus possible for small movements and tolerances to be compensated and at the same time for sealing of the energy store housing to be ensured. However, a disadvantage here is that the hoses require a certain amount of installation space.

It is an object of the present invention to reduce the above-described disadvantage while maintaining the above-described advantages.

According to one exemplary embodiment of the invention, an energy store housing having a cooling connection and having a coolant distributor for guiding coolant or refrigerant in the interior of the energy store housing is provided, wherein the cooling connection has the following elements: at least one connection pipe part, which is affixed to the coolant distributor; at least one sealing pipe part, which extends through a wall of the energy store housing such that, between the sealing pipe part and a wall opening, a gap surrounding the sealing pipe part remains, and an attachment having at least one attachment pipe part. The connection pipe part, the sealing pipe part and the attachment pipe part are components able to be fitted one on the other, which, when fitted together, form a pipeline via which the coolant distributor, for coolant or refrigerant circulation, is able to be reached from the outside of the energy store housing. The attachment is able to be mounted from the outside onto the sealing pipe part and the gap, with the result that the attachment closes off the gap, in particular closes off said gap at least in a liquid-tight manner. Consequently, the coolant distributor, in particular if this is of rigid form, is mechanically decoupled from the cooling connection, or the mechanical coupling is reduced, with the result that tolerances can be compensated and small movements are possible while at the same time sealing of the energy store housing is ensured.

According to a further exemplary embodiment of the invention, one longitudinal end of the connection pipe part surrounds one longitudinal end, pointing into the energy store housing, of the sealing pipe part in a ring-like manner.

According to a further exemplary embodiment of the invention, one longitudinal end, pointing out of the energy store housing, of the sealing pipe part projects into the attachment.

According to a further exemplary embodiment of the invention, the cooling connection has two connection pipe parts, two sealing pipe parts and the one attachment having two attachment pipe parts.

According to a further exemplary embodiment of the invention, in the state in which the connection pipe part, the sealing pipe part and the attachment pipe part are placed against one another, contact between the sealing pipe part and the connection pipe part is sealed off, at least in a liquid-tight manner, and contact between the sealing pipe part and the attachment is sealed off, at least in a liquid-tight manner.

According to a further exemplary embodiment of the invention, the attachment has a plate-like section from which the at least one attachment pipe part projects, in particular in a manner substantially perpendicular thereto.

According to a further exemplary embodiment of the invention, the attachment is composed of plastic.

According to a further exemplary embodiment of the invention, the connection pipe part is composed of aluminum.

The invention furthermore provides an energy store, in particular for the drive of a motor vehicle, having a plurality of energy storage modules which are electrically connected in series or parallel and which each have a plurality of storage cells which are electrically connected in series or parallel; an energy store housing according to one of the above exemplary embodiments, in which the energy storage modules are housed, wherein coolant or refrigerant of a coolant or refrigerant circuit is able to be fed or discharged via the attachment pipe part.

The present invention furthermore provides a motor vehicle having such an energy store.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a schematic illustration of a cooling connection from the prior art.

FIG. 2 is a schematic illustration of a cooling connection according to an exemplary embodiment of the invention.

FIG. 3 is a three-dimensional view of the exemplary embodiment of the cooling connection according to the invention.

### DETAILED DESCRIPTION OF THE DRAWINGS

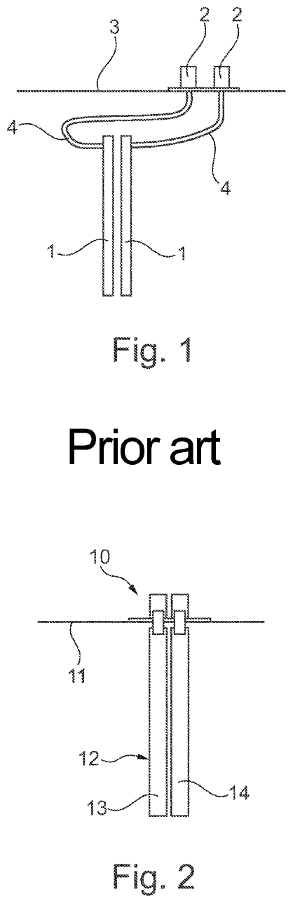

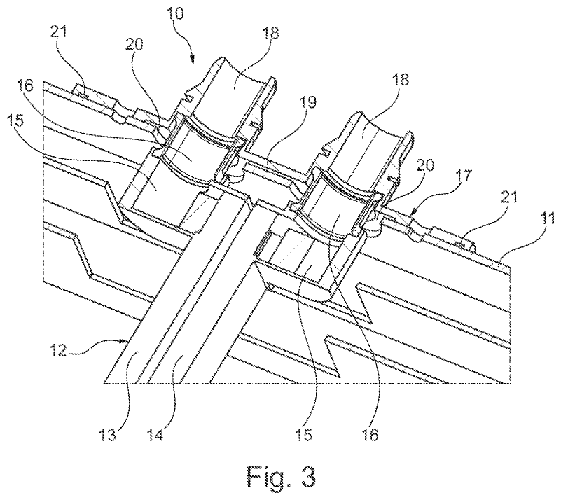

FIG. 2 is a schematic illustration of a cooling connection 10 according to an exemplary embodiment of the invention, and FIG. 3 is a three-dimensional view of the cooling connection 10. The cooling connection 10 is adapted for the feeding and/or discharge of a coolant or refrigerant, in particular a liquid, for cooling an energy store at an energy storage cooling arrangement. More precisely, the cooling connection 10 guides the coolant or refrigerant through a wall 11 of an energy store housing.

The energy store is an energy store for storing electrical energy and is preferably used as a traction energy store for the provision of drive energy of a purely electrically operated motor vehicle or of a hybrid vehicle. The motor vehicle is preferably a passenger motor vehicle, but may also be another motor vehicle. The energy store has multiple energy storage modules which are electrically connected in series or parallel. Each of said energy storage modules has a plurality of storage cells which are arranged directly in line with one another and are electrically connected in series or parallel. Preferably, the energy store has an output voltage of more than 45 volts, although this may also be more than 250 volts.

The energy storage modules are arranged in the energy store for example such that the energy storage modules are arranged in rows or are grouped in rows. It is preferably the case here that a longitudinal direction of an energy storage module is perpendicular to the longitudinal direction or stacking direction of a row. Within a row, the energy storage modules are arranged directly in line with one another. Between adjacent rows of energy storage modules, provision is made of a coolant distributor 12 which forms a line section of a cooling or refrigeration circuit in which the coolant or refrigerant circulates. In the illustrated exemplary embodiment, the coolant distributor 12 is realized in the form of two coolant channels 13 and 14. It may however also be a single integrally formed subdivided channel, as is described in DE 10 2017 204 194.3. Preferably, the at least one coolant channel 13, 14 is rectilinear and has a rectangular outer contour in cross section. The coolant distributor 12 has a supply line and a return line. In the illustrated case, the supply line is formed by the coolant channel 13 and the return line is formed by the coolant channel 14. In the case of an integral subdivided channel, the supply line and return line are formed by chambers of the channel that are separated from one another and that extend in a longitudinal direction. Preferably, the coolant distributor 12 is rigid. For the purpose of cooling the energy store, cooling elements (not illustrated), for example cooling plates, branch off from the coolant distributor 12.

The coolant distributor 12 is connected in a sealed-off manner, at least in a liquid-tight manner, to the cooling or refrigeration circuit (not illustrated) via the cooling connection 10. Despite this sealing, an energy store housing, of which merely the wall 11 is shown in the figures and which houses the energy store or the energy storage modules of the latter, has to prevent coolant or refrigerant escaping to the surroundings, that is to say outside the energy store housing, and is therefore likewise to be designed in a sealed manner, at least in a liquid-tight manner. The cooling connection 10 according to the invention ensures sealing and at the same time provides access to the coolant distributor 12 extending in the interior of the energy store housing.

The cooling connection 10 has two connection pipe parts 15, which are connected to the coolant distributor 12, in particular are fastened thereto, preferably are connected thereto so as not to be detachable without destruction, for example welded, soldered or adhesively bonded thereto. The interior of the connection pipe parts 15 is in each case connected to the supply line or return line of the coolant distributor 12. The connection pipe parts 15 are affixed to the coolant distributor 12 at least in a liquid-tight manner, in particular in a fluid-tight manner. For example, the connection pipe part 15 may be designed in the form of a cylindrical pipe which is open at one longitudinal end, which is closed off at the other longitudinal end and which, at one location of the cylinder surface, has an opening which opens into the supply line or return line. Preferably, the connection pipe parts 15 are produced from aluminum or some other metal. The cooling connection 10 also has two sealing pipe parts 16. In the installed state of the cooling connection 10, the sealing pipe parts 16 extend through the wall 11. Furthermore, the cooling connection 10 comprises an attachment 17 which has two attachment pipe parts 18. In each case one of the connection pipe parts 15, one of the sealing pipe parts 16 and one of the attachment pipe parts 17 are arranged directly in line with one another, with the result that they form a continuous pipe which connects an open opening of the attachment pipe part 18 to the supply line or return line of the coolant distributor 12. The attachment pipe parts 18 are formed integrally with a plate-like section 19 of the attachment 17, in particular in a monolithic manner. A longitudinal axis of the attachment pipe parts 18 is preferably perpendicular to the plane of the plate-like section 19. Preferably, the attachment 17 is produced from plastic.

The sealing pipe parts 16 extend through the wall 11 of the energy store housing. The openings in the wall 11 that are required for this purpose are preferably each larger than the outer diameter of the sealing pipe parts 16, with the result that a gap 20 surrounding the sealing pipe part 16 is formed in each case between the sealing pipe parts 16 and the openings. These gaps 20 are sealed off by the attachment 17. For this purpose, the plate 19 has for example a seal 21 which extends in the plate plane and which is annularly closed and which seals off, at least in a liquid-tight manner, between the plate 19 and the outer surface of the wall 11.

In the fitted state, in each case one longitudinal end of the connection pipe part 15 surrounds one longitudinal end of the sealing pipe part 16. This may however also be realized the other way round. The opposite longitudinal end of the sealing pipe part 16 projects into the attachment 17. The contact at both longitudinal ends of the sealing pipe parts 16 is sealed off, at least sealed off in a liquid-tight manner, with respect to the adjacent abutting component.

During the assembly, the coolant distributor 12 is situated with the connection pipe parts 15, fastened thereon, in the energy store housing. The sealing pipe parts 16 can be mounted from the outside onto the connection pipe parts 15 through the openings in the wall 11. Subsequently, the attachment 17 is mounted from the outside onto the wall 11 such that the attachment pipe parts 18 are mounted onto the sealing pipe parts 16. The attachment 17 is then fastened to the wall 11, for example riveted thereto, screwed thereto, welded thereto, soldered thereto, etc.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. An energy store housing having a coolant distributor for guiding coolant or refrigerant in an interior of the energy store housing, comprising:
a cooling connection of the energy store housing, the cooling connection comprising:
at least one connection pipe part, which is affixed to the coolant distributor;
at least one sealing pipe part, which extends through a wall of the energy store housing such that, between the sealing pipe part and a wall opening, a gap surrounding the sealing pipe part remains; and
an attachment having at least one attachment pipe part,
wherein the connection pipe part, the sealing pipe part and the attachment pipe part are components able to be fitted one on the other and, in a fitted-together state, form a pipeline via which the coolant distributor is able to be reached from outside of the energy store housing for coolant or refrigerant circulation, and
wherein the attachment is able to be mounted from the outside onto the sealing pipe part and the gap, wherein the attachment closes off the gap.

2. The energy store housing according to claim 1, wherein
one longitudinal end of the connection pipe part surrounds one longitudinal end, pointing into the energy store housing, of the sealing pipe part in a ring-like manner.

3. The energy store housing according to claim 2, wherein
one longitudinal end, pointing out of the energy store housing, of the sealing pipe part projects into the attachment.

4. The energy store housing according to claim 1, wherein
the cooling connection has two connection pipe parts, two sealing pipe parts, and the two attachment pipe parts.

5. The energy store housing according to claim 1, wherein
in a state in which the connection pipe part, the sealing pipe part and the attachment pipe part are fitted one on the other, contact between the sealing pipe part and the connection pipe part is sealed off, at least in a liquid-tight manner, and contact between the sealing pipe part and the attachment is sealed off, at least in a liquid-tight manner.

6. The energy store housing according to claim 1, wherein
the attachment has a plate-shaped section from which the at least one attachment pipe part projects.

7. The energy store housing according to claim 6, wherein
the at least one attachment pipe part projects in a manner substantially perpendicular to the plate-shaped section.

8. The energy store housing according to claim 1, wherein
the attachment is composed of plastic.

9. The energy store housing according to claim 1, wherein
the connection pipe part is composed of aluminum.

10. An energy store for a drive of a motor vehicle, comprising:
a plurality of energy storage modules which are electrically connected in series or parallel and which each have a plurality of storage cells which are electrically connected in series or parallel;
an energy store housing according to claim 1, wherein
the plurality of energy storage modules are housed in the energy store housing, and
coolant or refrigerant of a coolant or refrigerant circuit is able to be fed or discharged via the attachment pipe part.

11. A motor vehicle comprising an energy store according to claim 10.
